(19) United States
(12) Patent Application Publication
(10) Pub. No.: US 2026/0172609 A1
(43) Pub. Date: Jun. 18, 2026

(54) METHOD AND APPARATUS FOR REDUCING VISUAL ARTIFACTS INTRODUCED BY CROSS-COMPONENT ADAPTIVE FILTER

(71) Applicant: MEDIATEK INC., Hsin-Chu (TW)

(72) Inventors: Wen-Chun Lin, Hsinchu City (TW); Ching-Yeh Chen, Hsinchu City (TW); Tzu-Der Chuang, Hsinchu City (TW); Chih-Wei Hsu, Hsinchu City (TW); Yi-Wen Chen, San Jose, CA (US); Yu-Wen Huang, Hsinchu City (TW)

(73) Assignee: MEDIATEK INC., Hsin-Chu (TW)

(21) Appl. No.: 18/835,034

(22) PCT Filed: Feb. 1, 2024
(86) PCT No.: PCT/CN2024/075151

§ 371 Date: Aug. 1, 2024

Related U.S. Application Data
(60) Provisional application No. 63/483,772, filed on Feb. 8, 2023.

(51) Int. Cl. H04N 19/86; H04N 19/117; H04N 19/136; H04N 19/172; H04N 19/82

(52) U.S. Cl. CPC H04N 19/86; H04N 19/117; H04N 19/136; H04N 19/172; H04N 19/82

(57) ABSTRACT

A method for dealing with a cross-component adaptive loop filtering procedure includes: checking at least one attribute to generate a checking result, wherein the at least one attribute includes at least one of a temporal scaling attribute of a frame and a flatness attribute of a region within the frame; and managing a cross-component adaptive loop filter (CCALF) according to the checking result.

### BACKGROUND OF THE INVENTION

### 1. Field of the Invention

The present invention relates to video coding, and more particularly, to a method and apparatus for reducing visual artifacts introduced by a cross-component adaptive filter.

### 2. Description of the Prior Art

The conventional video coding standards generally adopt a block based coding technique to exploit spatial and temporal redundancy. For example, the basic approach is to divide the whole source picture into a plurality of blocks, perform intra/inter prediction on each block, transform residual of each block, and perform quantization and entropy encoding. Besides, a reconstructed picture is generated in a coding loop to provide reference data used for coding following blocks. For certain video coding standards, in-loop filter(s) may be used for enhancing the image quality of the reconstructed frame. The video decoder is used to perform an inverse operation of a video encoding operation performed by a video encoder. For example, the video decoder may have a plurality of processing circuits, such as an entropy decoding circuit, an intra prediction circuit, a motion compensation circuit, an inverse quantization circuit, an inverse transform circuit, a reconstruction circuit, and in-loop filter(s).

In-loop filter(s) can be used to reduce coding artifacts introduced by intra/inter prediction and residual coding. In accordance with the versatile video coding (VVC) standard, a cross-component adaptive filter (CCALF) is employed to improve the chroma fidelity. Specifically, CCALF applies a linear filter to process luma sample values and generate residual correction for chroma sample values. However, visual artifacts are produced when CCALF is always on. The reason is that CCALF amplifies artifacts introduced earlier. To keep the better visual quality, CCALF may be enabled when certain conditions are met. One of the constraints of enabling CCALF is based on the quantization parameter (QP). When the restriction of QP is removed, visual artifacts appear in some large QP frames, but no artifacts are seen in small QP frames. Furthermore, the artifacts exist before and after CCALF in large QP frames. It infers that artifacts in large QP frames are caused by propagation. In a case where the restriction of QP in enabling CCALF (e.g., the slice QP value minus 1 is less than or equal to the base QP value) is removed, there is a need for an innovative CCALF design with improved visual quality.

### SUMMARY OF THE INVENTION

One of the objectives of the claimed invention is to provide a method and apparatus for reducing visual artifacts introduced by a cross-component adaptive filter.

According to a first aspect of the present invention, an exemplary method for dealing with a cross-component adaptive loop filtering procedure is disclosed. The exemplary method includes: checking at least one attribute to generate a checking result, wherein the at least one attribute comprises at least one of a temporal scaling attribute of a frame and a flatness attribute of a region within the frame; and managing a cross-component adaptive loop filter (CCALF) according to the checking result.

According to a second aspect of the present invention, an exemplary method for dealing with a cross-component adaptive loop filtering procedure is disclosed. The exemplary method includes: determining a residual correction value by a cross-component adaptive loop filter (CCALF); and after the residual correction value is obtained, applying magnitude reduction to the residual correction value.

According to a third aspect of the present invention, an exemplary adaptive loop filter is disclosed. The exemplary adaptive loop filter includes a cross-component adaptive loop filter (CCALF) and a control circuit. The control circuit is arranged to check at least one attribute to generate a checking result, and manage the CCALF according to the checking result, wherein the at least one attribute comprises at least one of a temporal scaling attribute of a frame and a flatness attribute of a region within the frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a video encoder that supports the proposed CCALF design according to an embodiment of the present invention.

FIG. 2 is a block diagram illustrating a video decoder that supports the proposed CCALF design according to an embodiment of the present invention.

FIG. 3 is a diagram illustrating an ALF using a first CCALF design according to an embodiment of the present invention.

FIG. 4 is a diagram illustrating an ALF using a second CCALF design according to an embodiment of the present invention.

FIG. 5 is a diagram illustrating an ALF using a third CCALF design according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

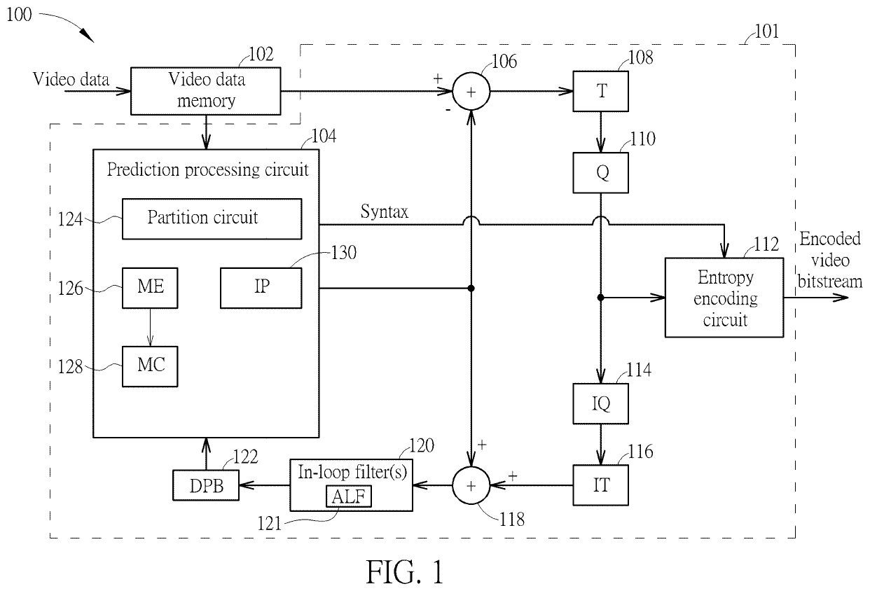

FIG. 1 is a block diagram illustrating a video encoder that supports the proposed CCALF design according to an embodiment of the present invention. By way of example, but not limitation, the video encoder 100 may be a VVC encoder. The video encoder 100 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence.

As shown in FIG. 1, the video encoder 100 includes an encoding circuit 101 and a video data memory 102. The video data memory 102 is arranged to receive data to be encoded. The encoding circuit 101 is arranged to perform encoding of the data buffered in the video data memory 102. The encoding circuit 101 may include a prediction processing circuit 104, a residual generation circuit 106, a transform circuit (labeled by “T”) 108, a quantization circuit (labeled by “Q”) 110, an entropy encoding circuit (e.g., a variable-length code (VLC) encoder) 112, an inverse transform circuit (labeled by “IQ”) 114, an inverse transform circuit (labeled by “IT”) 116, a reconstruction circuit 118, one or more in-loop filters 120, and a decoded picture buffer (DPB) 122. The prediction processing circuit 104 may include a partition circuit 124, a motion estimation circuit (labeled by “ME”) 126, a motion compensation circuit (labeled by “MC”) 128, and an intra prediction circuit (labeled by “IP”) 130. It should be noted that the prediction processing circuit 104 may support additional coding tools, depending upon actual design considerations. The in-loop filter(s) 120 may include an adaptive loop filter (ALF) 121, where the ALF 121 employs the proposed CCALF design.

It should be noted that the encoder architecture shown in FIG. 1 is for illustrative purposes only, and is not meant to be a limitation of the present invention. In practice, any video encoder using/supporting the proposed CCALF design falls within the scope of the present invention. As the present invention is focused on the proposed CCALF design employed by the ALF 121 and a person skilled in the art should readily understand details of other circuit components included in the video encoder 100, further description of principles of other circuit components included in the video encoder 100 is omitted here for brevity.

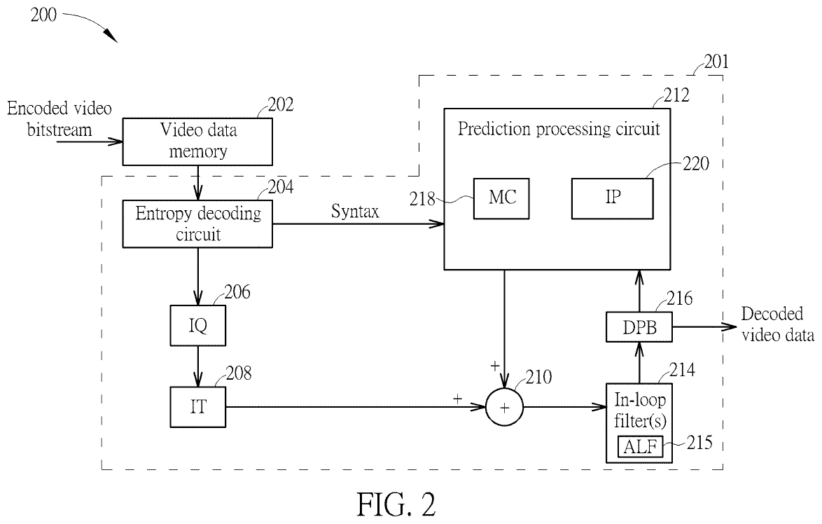

The proposed CCALF design may also be implemented in a video decoder. FIG. 2 is a block diagram illustrating a video decoder that supports the proposed CCALF design according to an embodiment of the present invention. By way of example, but not limitation, the video decoder 200 may be a VVC decoder. The video decoder 200 includes a decoding circuit 201 and a video data memory 202. The video data memory 202 is arranged to receive data to be decoded. The decoding circuit 201 is arranged to perform decoding of the data buffered in the video data memory 202. The decoding circuit 201 may include an entropy decoding circuit (e.g., a VLC decoder) 204, an inverse quantization circuit (labeled by “IQ”) 206, an inverse transform circuit (labeled by “IT”) 208, a reconstruction circuit 210, a prediction processing circuit 212, one or more in-loop filters 214, and a decoded picture buffer (DPB) 216. The prediction processing circuit 212 may include a motion compensation circuit (labeled by “MC”) 218 and an intra prediction circuit (labeled by “IP”) 220. It should be noted that the prediction processing circuit 212 may support additional coding tools, depending upon actual design considerations. The in-loop filter(s) 214 may include an ALF 215, where the ALF 215 employs the proposed CCALF design.

It should be noted that the decoder architecture shown in FIG. 2 is for illustrative purposes only, and is not meant to be a limitation of the present invention. In practice, any video decoder using/supporting the proposed CCALF design falls within the scope of the present invention. As the present invention is focused on the proposed CCALF design and a person skilled in the art should readily understand details of other circuit components included in the video decoder 200, further description of principles of other circuit components included in the video decoder 200 is omitted here for brevity.

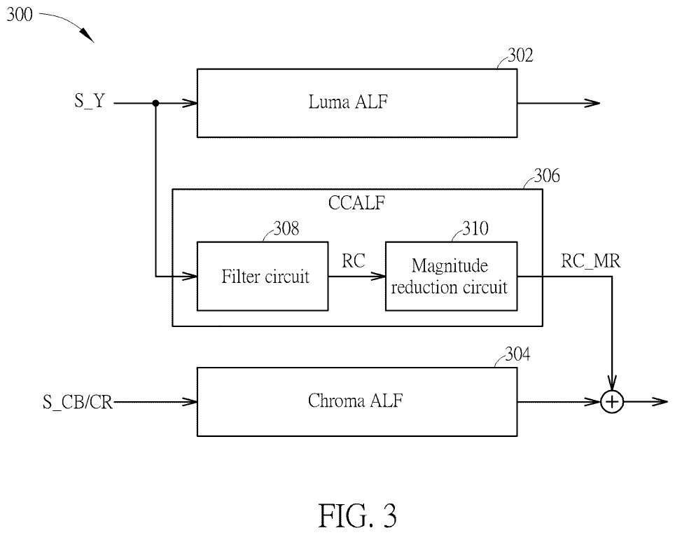

As mentioned above, the proposed CCALF design can be implemented in both of the video encoder 100 and the video decoder 200. FIG. 3 is a diagram illustrating an ALF using a first CCALF design according to an embodiment of the present invention. Any of the ALFs 121 and 215 may be implemented using the ALF 300. The ALF 300 includes a luma ALF 302, a chroma ALF 304, and a CCALF 306, where the CCALF 306 includes a filter circuit 308 and a magnitude reduction circuit 310. Luma sample values S_Y output from a preceding processing stage (e.g., a sample adaptive offset (SAO) filter, being one of the in-loop filters 120/214) are provided to the luma ALF 302 and the CCALF 306. Chroma sample values S_CB/CR output from the preceding processing stage (e.g., SAO filter) are provided to the chroma ALF 304. The filter circuit 308 of the CCALF 306 is arranged to generate a residual correction value RC for a target chroma sample. The filter circuit 308 of the CCALF 306 may be the same as that used in a typical CCALF design. The major difference between the typical CCALF design and the proposed CCALF design is that the CCALF 306 includes the magnitude reduction circuit 310 that is arranged to apply magnitude reduction to the residual correction value RC obtained by the filter circuit 308 and output a magnitude-reduced residual correction value RC MC for a chroma ALF output generated for the target chroma sample.

In some embodiments of the present invention, the magnitude reduction circuit 310 may perform a clipping function to achieve magnitude reduction of the residual correction value RC. Specifically, the residual correction value RC is clipped within a specific range. For example, the clipping function may be expressed using the following formula.

$$clipped residual correction = \{ \begin{matrix}- {2}^{N} , & residual correction < - {2}^{N} \\ residual correction , & - {2}^{N} \leq residual correction \leq {2}^{N} , where \\ {2}^{N} , & {2}^{N} < residual correction\end{matrix}$$

N is an integer smaller than the bit depth of pixels.

In some embodiments of the present invention, the magnitude reduction circuit 310 may perform a shifting function to achieve magnitude reduction of the residual correction value RC. Specifically, a bit-shift operation (e.g., a right-shift operation “>>”) is performed upon the residual correction value RC. For example, the shifting function may be expressed as follows: shifted residual correction=residual correction>>N, where N is an integer larger than 0.

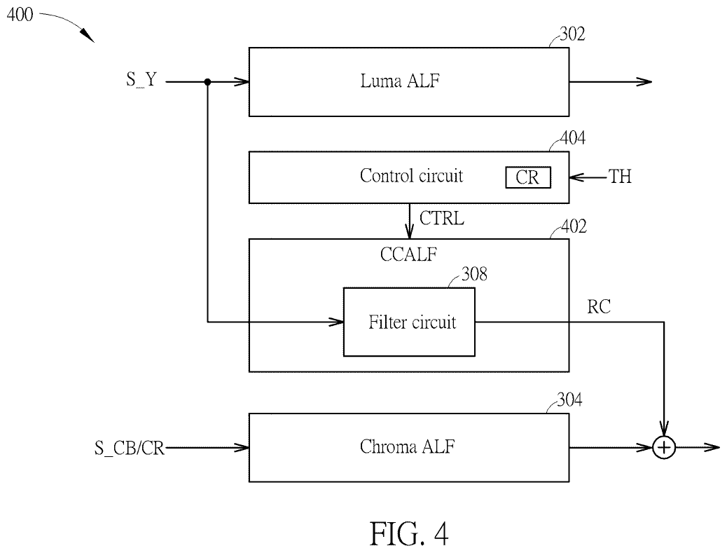

FIG. 4 is a diagram illustrating an ALF using a second CCALF design according to an embodiment of the present invention. Any of the ALFs 121 and 215 may be implemented using the ALF 400. The ALF 400 includes a CCALF 402, a control circuit 404, and the aforementioned luma ALF 302 and chroma ALF 304, where the CCALF 402 is implemented using the aforementioned filter circuit 308. In this embodiment, the control circuit 404 is arranged to manage the CCALF 402. For example, the control circuit 404 is arranged to check at least one attribute to generate a checking result CR, and manage the CCALF 402 according to the checking result CR, where the at least one attribute includes at least one of a temporal scaling attribute of a frame and a flatness attribute of a region within the frame.

In some embodiments of the present invention, the control circuit 404 is arranged to generate the checking result CR by comparing at least one parameter of the at least one attribute with a threshold setting TH, where the threshold setting TH may include one or more threshold values. For example, the threshold setting TH used by CCALF 400 (which is a part of ALF 121 at the video encoder 100) is encoded by the entropy encoding circuit 112, and is signalled to the video decoder 200 via the encoded video bitstream. The threshold setting TH may be signalled in a sequence level, a picture level, or a slice level. Hence, the entropy decoding circuit 204 parses the threshold setting TH from the encoded video bitstreams, and provides the parsed threshold setting TH to CCALF 400 (which is a part of ALF 215 at the video decoder 200). In this way, the same threshold setting TH can be used by both of the video encoder 100 and the video decoder 200. For another example, the threshold setting TH is a predefined setting used by both of the video encoder 100 and the video decoder 200, where the predefined setting is not required to be signalled from the video encoder 100 to the video decoder 200.

In some embodiments of the present invention, the at least one attribute may include the temporal scaling attribute of the frame, and the at least one parameter of the at least one attribute may include a temporal layer index of the frame. According to the coding order, low temporal layer frames are more likely to be referenced by other frames. Hence, it is better to disable CCALF for these frames to avoid propagation of artifacts. When the checking result CR indicates that the temporal layer index of the frame is lower than the threshold setting TH, the control circuit 404 outputs a control signal CTRL (e.g., CTRL=1) to disable the CCALF 402, such that no residual correction is generated for chroma samples of the frame being a low temporal layer frame. Otherwise, the control circuit 404 outputs the control signal CTRL (e.g., CTRL=0) to enable the CCALF 402 for the frame being a high temporal layer frame.

Artifacts may appear in large QP frames due to propagation. Basically, high temporal layer frames are coded by large QP. In some embodiments of the present invention, CCALF may be disabled for high temporal layer frames to avoid propagation of artifacts. When the checking result CR indicates that the temporal layer index of the frame is higher than the threshold setting TH, the control circuit 404 outputs the control signal CTRL (e.g., CTRL=1) to disable the CCALF 402, such that no residual correction is generated for chroma samples of the frame being a high temporal layer frame. Otherwise, the control circuit 404 outputs the control signal CTRL (e.g., CTRL=0) to enable the CCALF 402 for the frame being a low temporal layer frame.

It should be noted that the threshold setting TH (e.g., TH=V1) used in a case where CCALF is disabled for low temporal layer frames and the threshold setting TH (e.g., TH=V2) used in another case where CCALF is disabled for high temporal layer frames may be set by the same value (V1=V2) or different values (V1=V2). That is, the threshold setting TH used by the control circuit 404 in FIG. 4 for distinguishing between low temporal layer frames and high temporal layer frames may be adjusted, depending upon actual design considerations. The present invention has no limitations on the value assignment of threshold setting TH.

In some embodiments of the present invention, the at least one attribute may include the flatness attribute of the region within the frame, and the checking result CR is generated to indicate whether the region is a flat region or a textured region. The region to be detected may be one M×N block, one coding unit (CU), or one coding tree unit (CTU). For a flat region, the information of luma samples may be unreliable since the fine changes may be noise. Therefore, when the checking result CR indicates that the region is a flat region, the control circuit 404 outputs the control signal CTRL (e.g., CTRL=1) to disable the CCALF 402, such that no residual correction is generated for chroma samples within the region being a flat region. Otherwise, the control circuit 404 outputs the control signal CTRL (e.g., CTRL=0) to enable the CCALF 402 for the region being a textured region.

In some embodiments of the present invention, the at least one attribute may include the flatness attribute of the region within the frame, and the at least one parameter of the at least one attribute may include variance of luma values within the region of the frame. If the variance of luma values within the region is smaller than the threshold setting TH, this region is treated as a flat region, and the CCALF 402 is disabled under control of the control circuit 404. Otherwise, it is treated as a textured region, and the CCALF 402 is enabled under control of the control circuit 404. By way of example, but not limitation, the control circuit 404 may refer to mean of luma values within the region to determine the threshold setting TH. That is, the threshold setting TH may be dependent on the mean of luma values within the region.

In some embodiments of the present invention, the at least one attribute may include the flatness attribute of the region within the frame, and the at least one parameter of the at least one attribute may include variance of chroma values within the region of the frame. If the variance of chroma values within the region is smaller than the threshold setting TH, this region is treated as a flat region, and the CCALF 402 is disabled under control of the control circuit 404. Otherwise, it is treated as a textured region, and the CCALF 402 is enabled under control of the control circuit 404. By way of example, but not limitation, the control circuit 404 may refer to mean of chroma values within the region to determine the threshold setting TH. That is, the threshold setting TH may be dependent on the mean of chroma values within the region.

In some embodiments of the present invention, the at least one attribute may include the flatness attribute of the region within the frame, and the at least one parameter of the at least one attribute may include variance of luma values within the region of the frame and variance of chroma values within the region of the frame. That is, the variance of luma values within the region and the variance of chroma values within the region are jointly considered to detect if the region is a flat region. The threshold setting TH may include two threshold values TH1 and TH2. If the variance of luma values within the region is larger than one threshold setting TH1 and the variance of chroma values within the region is smaller than another threshold setting TH2, this region is treated as a flat region, and the CCALF 402 is disabled under control of the control circuit 404. Otherwise, it is treated as a textured region, and the CCALF 402 is enabled under control of the control circuit 404. By way of example, but not limitation, the control circuit 404 may refer to mean of luma values within the region and mean of chroma values within the region to determine the threshold setting TH (which may include different threshold values TH1 and TH2). That is, the threshold setting TH may be dependent on the mean of luma values within the region and the mean of chroma values within the region.

Regarding the embodiment shown in FIG. 4, the CCALF 402 is disabled to avoid artifact propagation when a flatness based condition or a temporal scaling based condition is met. In an alternative design, the “CCALF off” function in FIG. 4 may be replaced by the “magnitude reduction” function in FIG. 3. That is, magnitude reduction is applied to a residual correction value obtained by the CCALF when a flatness based condition or a temporal scaling based condition is met.

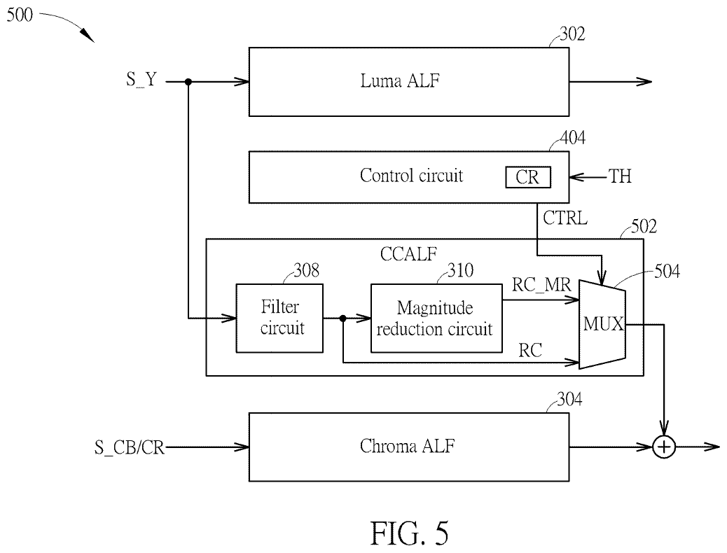

FIG. 5 is a diagram illustrating an ALF using a third CCALF design according to an embodiment of the present invention. Any of the ALFs 121 and 215 may be implemented using the ALF 500. The ALF 500 includes a CCALF 502 and the aforementioned control circuit 404, luma ALF 302 and chroma ALF 304, where the CCALF 502 includes a multiplexer (MUX) 504 and the aforementioned filter circuit 308 and magnitude reduction circuit 310. In this embodiment, the control circuit 404 is arranged to manage the CCALF 502. For example, the control circuit 404 is arranged to check at least one attribute to generate a checking result CR, and manage the CCALF 502 according to the checking result CR, where the at least one attribute includes at least one of a temporal scaling attribute of a frame and a flatness attribute of a region within the frame.

The filter circuit 308 is arranged to generate a residual correction value RC for a target chroma sample. The magnitude reduction circuit 310 is arranged to perform a clipping function or a shifting function to achieve magnitude reduction of the residual correction value RC. The MUX 504 is controlled by the control signal CTRL that is generated and set by the control circuit 404 according to the checking result CR.

For example, when the checking result CR indicates that the temporal layer index of the frame is lower than the threshold setting TH, the control circuit 404 outputs the control signal CTRL (e.g., CTRL=1) to select the magnitude-reduced residual correction value RC_MR as an output of the MUX 504. Otherwise, the control circuit 404 outputs the control signal CTRL (e.g., CTRL=0) to select the residual correction value RC as an output of the MUX 504. Alternatively, when the checking result CR indicates that the temporal layer index of the frame is higher than the threshold setting TH, the control circuit 404 outputs the control signal CTRL (e.g., CTRL=1) to select the magnitude-reduced residual correction value RC_MR as an output of the MUX 504. Otherwise, the control circuit 404 outputs the control signal CTRL (e.g., CTRL=0) to select the residual correction value RC as an output of the MUX 504.

It should be noted that the threshold setting TH (e.g., TH=V1) used in a case where magnitude reduction is applied for low temporal layer frames and the threshold setting TH (e.g., TH=V2) used in another case where magnitude reduction is applied for high temporal layer frames may be set by the same value (V1=V2) or different values (V1=V2). That is, the threshold setting TH used by the control circuit 404 in FIG. 5 for distinguishing between low temporal layer frames and high temporal layer frames may be adjusted, depending upon actual design considerations. The present invention has no limitations on the value assignment of threshold setting TH.

For another example, when the checking result CR indicates that the region within the frame is a flat region, the control circuit 404 outputs the control signal CTRL (e.g., CTRL=1) to select the magnitude-reduced residual correction value RC_MR as an output of the MUX 504. Otherwise, the control circuit 404 outputs the control signal CTRL (e.g., CTRL=0) to select the residual correction value RC as an output of the MUX 504.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for dealing with a cross-component adaptive loop filtering procedure, comprising:
checking at least one attribute to generate a checking result, wherein the at least one attribute comprises at least one of a temporal scaling attribute of a frame and a flatness attribute of a region within the frame; and
managing a cross-component adaptive loop filter (CCALF) according to the checking result.

2. The method of claim 1, wherein checking the at least one attribute to generate the checking result comprises:
comparing at least one parameter of the at least one attribute with a threshold setting to generate the checking result.

3. The method of claim 2, wherein the threshold setting is signalled in a sequence level, a picture level, or a slice level.

4. The method of claim 2, wherein the threshold setting is a predefined setting.

5. The method of claim 2, wherein the at least one attribute comprises the temporal scaling attribute of the frame, and the at least one parameter of the at least one attribute comprises a temporal layer index of the frame.

6. The method of claim 2, wherein the at least one attribute comprises the flatness attribute of the region within the frame, and the at least one parameter of the at least one attribute comprises variance of luma values within the region.

7. The method of claim 6, wherein checking the at least one attribute to generate the checking result further comprises:
referring to mean of the luma values within the region to determine the threshold setting.

8. The method of claim 2, wherein the at least one attribute comprises the flatness attribute of the region within the frame, and the at least one parameter of the at least one attribute comprises variance of chroma values within the region.

9. The method of claim 8, wherein checking the at least one attribute to generate the checking result further comprises:
referring to mean of the chroma values within the region to determine the threshold setting.

10. The method of claim 2, wherein the at least one attribute comprises the flatness attribute of the region within the frame, and the at least one parameter of the at least one attribute comprises variance of luma values within the region and variance of chroma values within the region.

11. The method of claim 10, wherein checking the at least one attribute to generate the checking result further comprises:
referring to mean of the luma values within the region and mean of the chroma values within the region to determine the threshold setting.

12. The method of claim 1, wherein the at least one attribute comprises the temporal scaling attribute of the frame, and managing the CCALF according to the checking result comprises:
in response to the checking result indicating that a temporal layer index of the frame is lower than a first threshold, disabling the CCALF; or
in response to the checking result indicating that the temporal layer index of the frame is higher than a second threshold, disabling the CCALF.

13. The method of claim 1, wherein the at least one attribute comprises the flatness attribute of the region within the frame, and managing the CCALF according to the checking result comprises:
in response to the checking result indicating that the region is a flat region, disabling the CCALF.

14. The method of claim 1, wherein the at least one attribute comprises the temporal scaling attribute of the frame, and managing the CCALF according to the checking result comprises:
in response to the checking result indicating that a temporal layer index of the frame is lower than a first threshold, applying magnitude reduction to a residual correction value after the residual correction value is obtained by the CCALF; or
in response to the checking result indicating that the temporal layer index of the frame is higher than a second threshold, applying magnitude reduction to the residual correction value after the residual correction value is obtained by the CCALF.

15. The method of claim 14, wherein the magnitude reduction comprises a clipping operation or a shifting operation.

16. The method of claim 1, wherein the at least one attribute comprises the flatness attribute of the frame, and managing the CCALF according to the checking result comprises:
in response to the checking result indicating that the region is a flat region, applying magnitude reduction to a residual correction value after the residual correction value is obtained by the CCALF.

17. The method of claim 16, wherein the magnitude reduction comprises a clipping operation or a shifting operation.

18. A method for dealing with a cross-component adaptive loop filtering procedure, comprising:
determining a residual correction value by a cross-component adaptive loop filter (CCALF); and
after the residual correction value is obtained, applying magnitude reduction to the residual correction value.

19. The method of claim 18, wherein the magnitude reduction comprises a clipping operation or a shifting operation.

20. An adaptive loop filter comprising:
a cross-component adaptive loop filter (CCALF); and
a control circuit, arranged to check at least one attribute to generate a checking result, and manage the CCALF according to the checking result, wherein the at least one attribute comprises at least one of a temporal scaling attribute of a frame and a flatness attribute of a region within the frame.
